(19) United States
(12) Patent Application Publication
(10) Pub. No.: US 2003/0178842 A1
(43) Pub. Date: Sep. 25, 2003

(54) Pipe assembly

(76) Inventor: John Gallagher, Aberdeen (GB)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/343,909

(22) PCT Filed: Aug. 8, 2001
(86) PCT No.: PCT/GB01/03573

(51) Int. Cl. F16L 55/00

(52) U.S. Cl. 285/123.15; 285/45

(57) ABSTRACT

A pipe-in assembly comprising an inner pipe unit (7) fixedly mounted within an outer pipe unit (6), each end of the inner pipe unit having a coupling means (3,4) for engagement with a complementary coupling means on an adjacent pipe-in-pipe assembly and arranged such that abutment of in end of the outer pipe unit with an end of the outer pipe unit of aid adjacent pipe-in-pipe assembly brings the inner pipe coupling means of the adjacent assemblies into sealed engagement.

The present invention relates to pipe assemblies particularly but not exclusively pipe assemblies for use in the oil industry.

In deep water applications the water temperature may be low enough to cause waxing of oil in a pipeline. Unless measures are taken to prevent the waxing the pipeline may become blocked and in this regard it is known to use a pipe-in-pipe construction in deep water application. The external cavity between the inner and outer pipes carries a heated fluid or an insulating material to keep the temperature of oil flowing through the inner pipe above the temperature at which waxing may occur.

In known pipe-in-pipe construction system, a section of outer pipe is positioned on the deck of a pipe-laying vessel and an inner pipe section is positioned within the outer pipe. A further section of inner pipe is positioned against the first inner pipe section, the two sections inner pipe are welded together, and the weld is inspected for flaws. A second section of outer pipe is positioned over the second inner pipe section and welded to the first outer pipe section before being inspected for flaws. This process is continued and the resultant pipe-in-pipe construction is lowered to the sea bed as a continuous string or in discrete sections. Although these known systems have a proven track record with a high level of reliability, the cost of constructing and laying the pipe-in-pipe system is very high. and welding and inspection of both the inner and outer welds is time consuming. Also, the large amount of welding consumables and energy needs adds to the cost of laying the pipeline.

The present invention addresses these drawbacks, and it provides a pipe-in-pipe assembly comprising an inner pipe unit fixedly mounted within an outer pipe unit, each end of the inner pipe unit having a coupling member for engagement with a complementary coupling member on an adjacent pipe-in-pipe assembly and arranged such that abutment of an end of the outer pipe unit with an end of the outer pipe unit of said adjacent pipe-in-pipe assembly brings the inner pipe coupling members of the adjacent assemblies into sealed engagement.

By dispensing with the need to weld the inner pipes together, pipe-in-pipe assemblies according to the present invention can be assembled approximately twice as fast as known systems.

Preferably, each inner coupling member comprises a tubular member having a generally frusto-conical peripheral surface for engagement with a complementary surface of said inner coupling member of the adjacent pipe-in-pipe assembly. The frusto-conical surface of the inner coupling member may have a plurality of circumferentially extending teeth for inter-engagement with teeth on the inner coupling member of the adjacent pipe-in-pipe assembly. However, preferably the frusto-conical surfaces are devoid of projections.

The inner coupling members may be formed integrally with the inner pipe.

To mount the inner pipe fixedly within the outer pipe, the inner and outer pipes may have opposed pairs of confronting annular projections. A spacing ring may be positioned between each pair of confronting projections and preferably the spacing ring has low thermal and electrical conductivity to insulate the inner and outer pipes from each other.

In an exemplary embodiment, sealing means are provided adjacent the free ends of the inner coupling members.

According to a further aspect of the present invention there is provided a string of connected pipe-in-pipe assemblies, each assembly being as defined above.

In an alternative configuration, the inner pipe unit is not fixedly mounted within the outer pipe unit during make up of the assembly. The inner pipe unit is releasably secured relative to the outer pipe with an end of the inner pipe unit projecting from the outer pipe unit. The coupling member of the projected end of the inner pipe unit is brought into sealed engagement with the coupling member of an adjacent assembly and the outer pipe unit is released to allow axial movement relative to the inner pipe unit. Thus the coupling member of the outer pipe unit can be brought into sealed engagement with the coupling member of the adjacent assembly.

Thus, according to another aspect of the present invention, there is provided a method of assembling a string of pipe-in-pipe assemblies, each assembly comprising inner and outer pipe units having coupling members for engagement with complementary coupling members on adjacent assemblies, the method comprising the steps of:

i) releasably securing the inner pipe unit of a first assembly relative to the outer pipe unit of said assembly with an end of the inner pipe unit projecting from the outer pipe unit;

ii) bring the coupling member of the projecting inner pipe unit of the first assembly into sealed engagement with the coupling member of the inner pipe unit of an adjacent assembly which forms part of an assembled string of pipe-in-pipe assemblies;

iii) releasing the outer pipe unit of the first assembly for axial movement relative to the inner pipe unit ,of the first assembly; and

iv) bringing the coupling member of the outer pipe unit into sealed engagement with the coupling members of the adjacent assembly.

This method allows a single make-up tool to be used to secure the inner and outer coupling members, and it allows the integrity of the seal formed at the inner coupling members to be tested before the outer joint is made up.

A clear understanding of the invention will be gained from the following drawing in which:

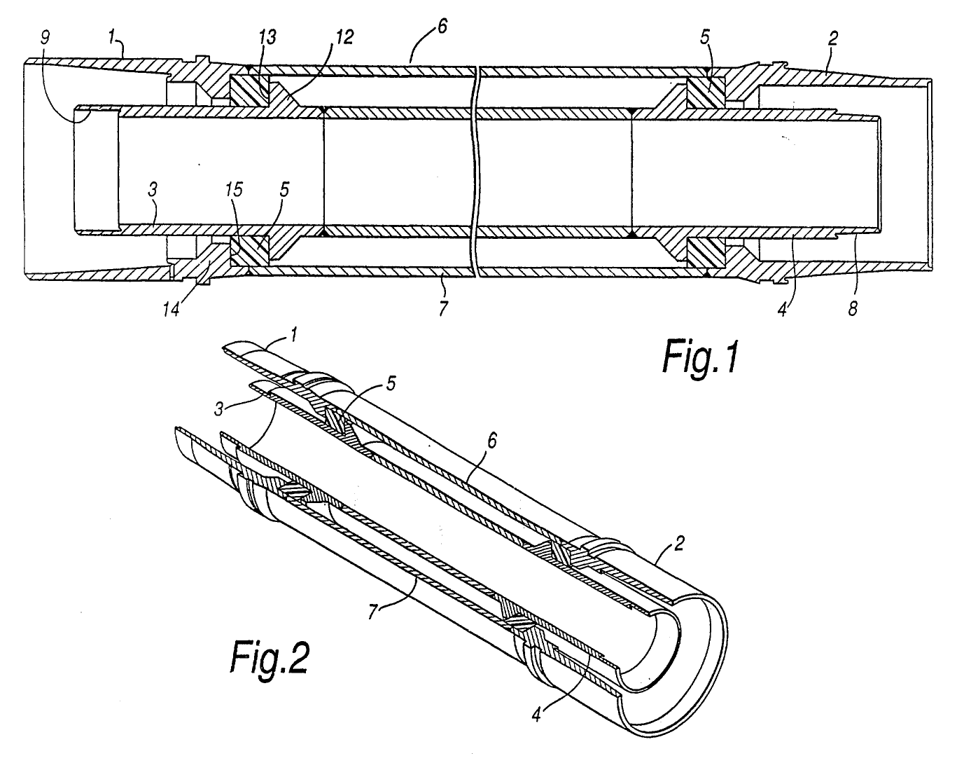

FIG. 1 is a sectional view through a pipe-in-pipe assembly according to a first aspect of the invention;

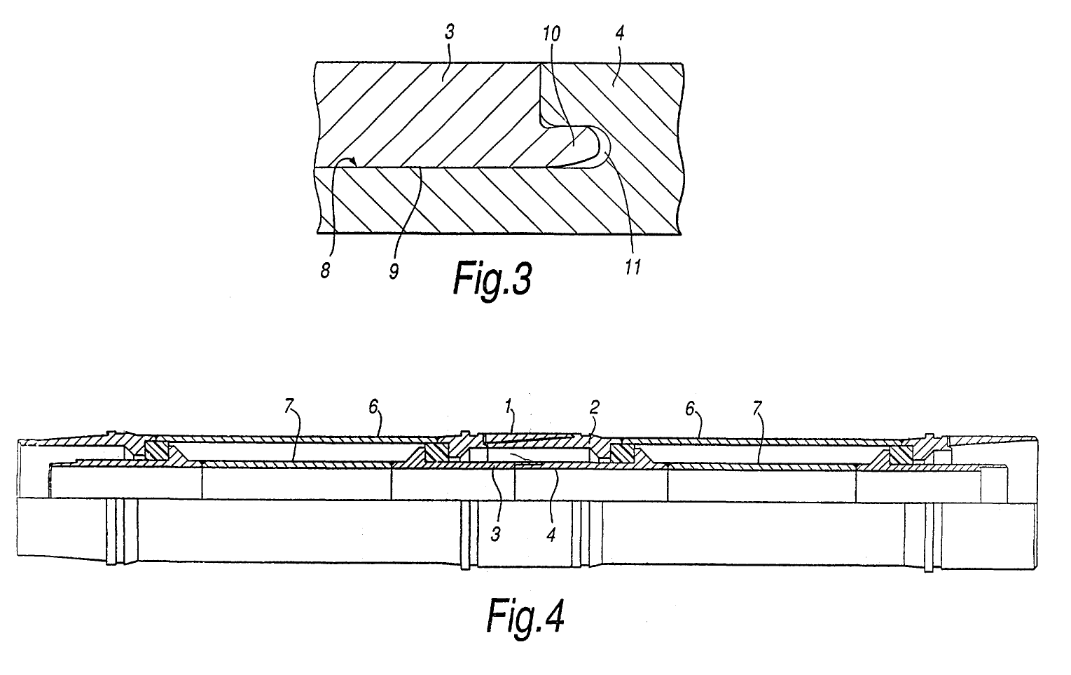

FIG. 2 is an isometric view of the assembly of FIG. 1, shown partially cut away;

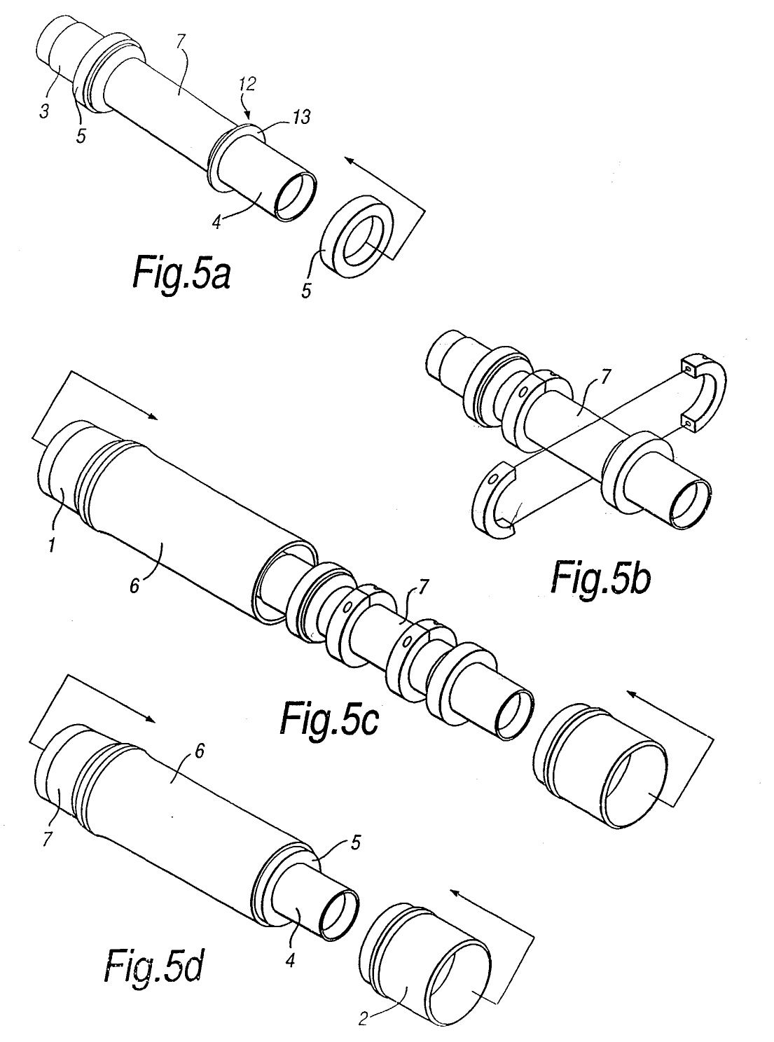

FIG. 3 is an enlarged partial sectional view of a pair of fully engaged inner coupling members;

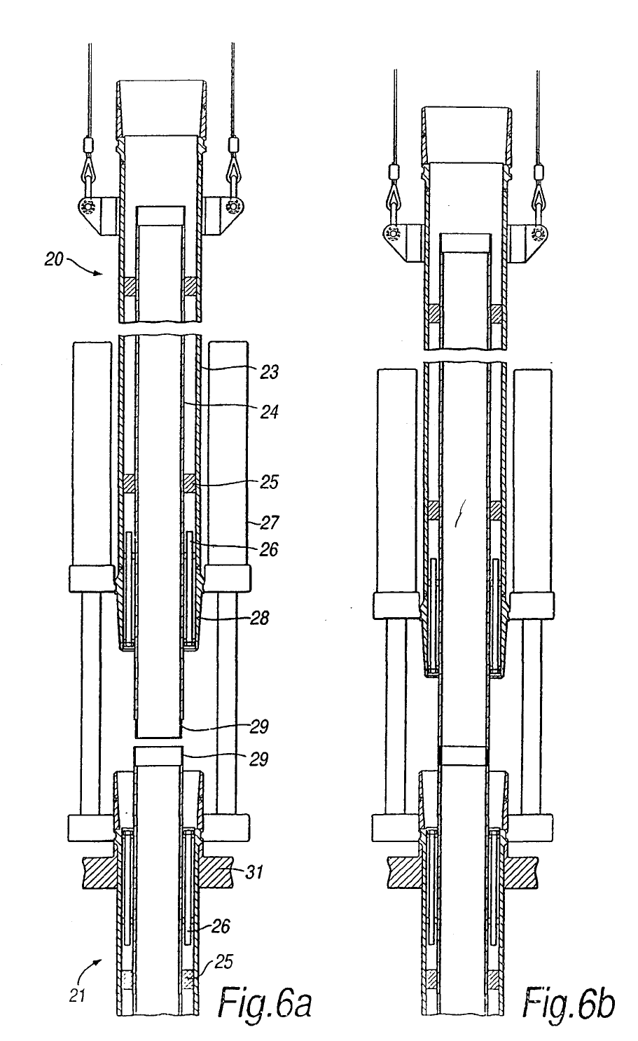

FIG. 4 shows a quarter section through two assemblies of the first aspect of the invention made up into a string;

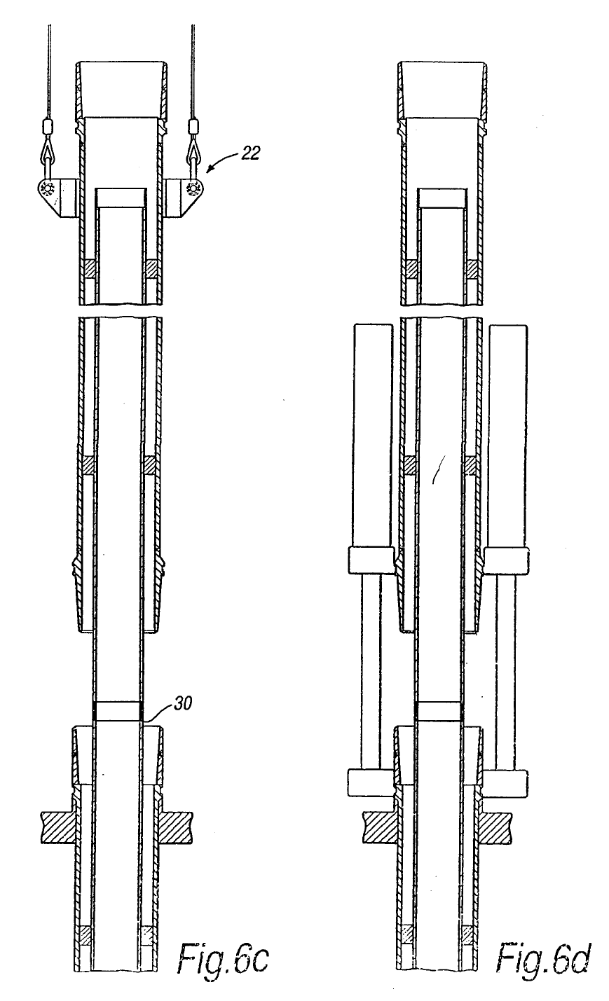

FIGS. 5a and 5b, show isometric views of the pipe-in-pipe assembly during various stages of construction;

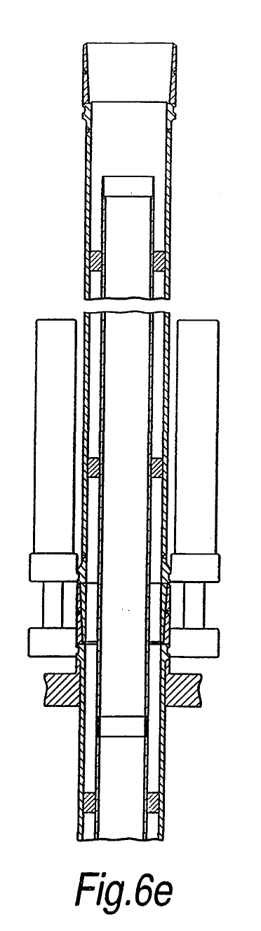

FIGS. 6a to 6eshow sectional views of a pipe-in-pipe assembly according to another aspect of the invention during assembly; and

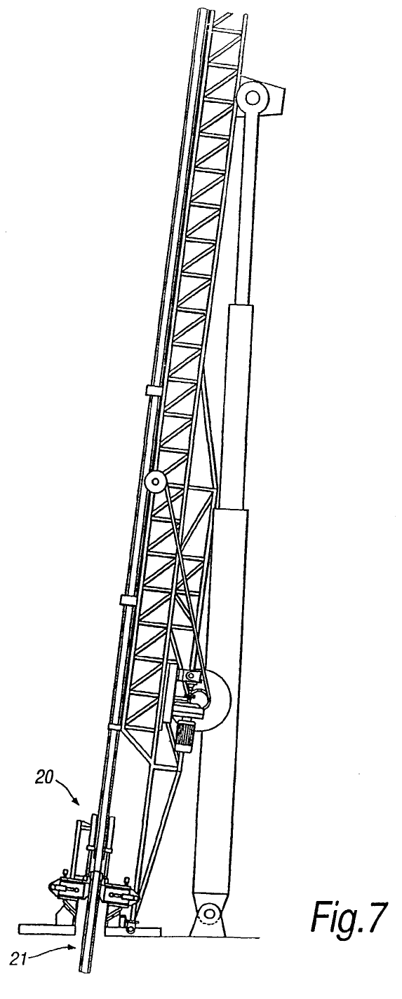

FIG. 7 is an illustrative view of a string of pipe-in-pipe assemblies during assembly.

FIGS. 1 and 2 show coupling members 1 to 4 connected, e.g. by welding, to the ends of inner and outer pipes 7,6. The male inner coupling member has at its outermost end a generally frusto-conical outer surface, and the female inner coupling member 3 has a complementary frusto-conical inner surface 9. To ensure sealing of the inner pipe 7 when male and female coupling members are brought into full engagement, the free end of each inner coupling member is provided with an annular axially extending tongue 10 and corresponding groove 11 (see FIG. 3). The tongue 10 is in full interference fit with the corresponding groove 11 on the adjacent inner coupling member when the coupling members 3,4 are fully engaged. The tongue and groove arrangement also provides radial restraint of the free ends of the coupling member 3,4. Between the free ends of the coupling members 3,4 and the join with the inner pipe 7, a radial annular projection or collar 12 extends outwardly of the inner pipe. Each collar 12 has abutment surfaces 13 facing the free end of the associated coupling member and projecting orthogonally to the outer surface of the coupling member. With the inner pipe 7 and coupling members 3,4 centrally disposed within the outer pipe and its associated coupling members 1,2, the free ends of the outer coupling members 1,2 extend beyond the free ends of the inner coupling members 3,4. The outer coupling members 1,2 are dimensioned so that the inner coupling member of the associated pipe-in-pipe assemblies are brought into full engagement at the same time as the outer coupling members. The outer coupling members 1,2 have inwardly extending annular projecting collars 14, with an abutment surface 15 directed away from the proximal free ends of the associated outer coupling member. In the assembled, condition a spacing ring or annulus 5 is firmly held between the confronting abutment surfaces 13,15 of the inner and outer pipes to prevent radial or axial movement of the inner pipe 7 relative to the outer pipe 6.

The annulus 5 is preferably formed from a material such as nylon or the like having low thermal and electrical conductivity to insulate the inner and outer pipes thermally and electrically, thus reducing thermal losses, preventing static build-up being transferred between the pipes and allowing for electrical communication to take place along the pipeline using pipes as wires.

The outer pipe connectors are preferably of the type described in GB 1573945, GB 2033518, GB 2099529, GB 2113333 and GB 2138089, details of which are incorporated by reference. This type of pipe connector comprises a tubular pin member having a generally frusto-conical peripheral surface and a tubular box member having a generally frusto-conical inner peripheral surface corresponding to the frusto-conical outer peripheral surf ace of the pin member. In use, the two members, each associated with a pipe section, are telescoped together and are axially locked t nether by inter-engagable annular teeth on the said peripheral surfaces. i.e. pin and box members are initially telescoped until surface contact is made between crest surfaces of the teeth at least at the ends of the overlapped portions of the frusto-conical surfaces. Hydraulic fluid under pressure is then supplied between the overlapped parts of the surfaces to expand the body member and/or contract the pin member to permit the members to be fully telescoped together. Pressurised hydraulic fluid is also used to disengage the members by expanding the box member and/or contracting the pin member to bring the teeth out of engagement.

The outer members 1,2 differ from the inner members 3,4 because the inner members 3,4 can be brought into full engagement using driving force alone, i.e. without the use of pressurised fluid or other connection facilitators. The frusto-conical surfaces of the inner members 3,4 may be provided with annular teeth or which may be entirely devoid of teeth.

FIGS. 5a to 5d show various stages in the construction of a pipe-in-pipe assembly according to the invention. In FIG. 5a the inner coupling members 3,4 have been welded to the inner pipe 7 and one nylon annulus 5 has been slid into abutment with the surface 13 of the annular projection 12. A second nylon annulus is slid into abutment with the surface 13 of the projection of the coupling member at the other end of the inner pipe, and further nylon annuli and other insulation material may be secured to the inner pipe between the annular projections 12 (FIG. 5b). The inner pipe is then inserted into an outer pipe have one outer coupling member welded to an end (FIG. Sc). A second outer coupling member is positioned over the exposed inner pipe end and welded into position (FIG. 5d). The alignment of the inner pipe relative to the outer pipe is checked to ensure the inner pipe and coupling members are positioned centrally within the outer coupling members.

The finished assembly can then be transported off-shore were a string of pipe-in-pipe assemblies can be formed simply by bringing the outer coupling member into full engagement, thereby removing the need for separate connection of the inner pipe joints and significantly reducing make up time.

Of course, the skilled person will understand that modifications can be made to the embodiments of the invention described above without departing from the scope of the claims. For instances, although each pipe-in-pipe assembly is shown with pairs of male and female coupling members, alternate assemblies could have only male or only female connections. Further, sealing means such as an elastomeric O-ring may be provided adjacent the free ends of the inner coupling members as an alternative to or in addition to the tongue and groove arrangement described above. Also rather than using the outer coupling members of the type described above, other coupling members could be utilised or the joint between the outer pipes could be welded Even if the outer joint is welded, the removal of the need to weld the inner pipe joint separately considerably reduces the time and cost of assembling a string of units. Each annulus 5 may have axial opening or apertures to permit fluid communication along the length of the outer cavity defined by a˜string of connected assemblies.

It is preferred to dispose the inner pipe 7 and associated coupling member 3,4 centrally within the outer pipe 6 and associated coupling members 1,2, but the inner pipe 7 could be offset axially or radially relative to the outer pipe 6. Indeed, one end of the inner pipe unit may project beyond the outermost extent of the outer pipe unit provided the relative dimensions of the inner and outer pipe units are maintained to ensure the inner coupling members are brought into sealed engagement contemporaneously with the full engagement of the outer coupling members. Whilst the invention has been described with reference to the connection of single pipe units, it is equally applicable to the connection of strings of pipes previously connected by other methods, such as welding.

FIGS. 6 and 7 show a pipe-in-pipe assembly according to another aspect of the present invention. With reference to FIG. 6a, the upper end of the outer pipe 23 of a pipe-in-pipe assembly 20, which is to be connected to a string of previously assembled assemblies 21, is held by a friction clamp 22. The inner pipe 24 of the assembly 20 projects down from and out of the outer pipe 23. Annular spacers 25 are housed between the pipes 23 and 24 and the inner pipe is held in place by an annular clamping assembly 26. A make-up tool 27 clamps onto a clamping grooves of the coupling members 28 of the adjacent outer pipes.

Compression of the make-up tool 27 brings the inner coupling members 29 of the adjacent assemblies into sealed engagement (FIG. 6b). The internal integrity of the seal between the connected inner coupling members can be tested at this point, e.g. by using a pressurised liquid or gas injected through an entry port 30 of the female coupling member (FIG. 6c). The inner coupling members 29 may have inter-engagable annular teeth on abutting surfaces, and fluid may be supplied under pressure to permit the inner members 29 to be fully telescoped together. Similarly a pressurized hydraulic fluid may be used to break the inner coupling members apart.

With the friction clamp 22 supporting the weight of the joint, the makeup tool 27 is removed from the two outer coupling members 28. The annular clamps 26 are then removed to allow the outer pipe 23 to slide axially relative to the inner pipe 24. Once the axial clamps have been removed the make-up tool 27 re-engages with the clamping grooves of the outer connectors 28. At this point the friction clamp 22 is removed (as the tool 27 is now holding the weight of the new pipe). The tool then makes up the outer connection in the manner described in British patent application GB 1573945 and the other patent applications referred to above.

The spacers 25 maintain the relative axial separation between the pipes 23, 24. After release of the friction clamp 22 and re-attachment of the make-up tool 27, the outer coupling members 28 can be brought into sealed engagement by further contraction of the make-up tool. Throughout the procedure the lower end of the lower outer pipe is supported by an abutment 31.

The clamp 26 could be manually or hydraulically operated, and it is preferably formed in two halves to facilitate remove after connection of the inner clamping members. Clamping members may be required at certain intervals along the string of pipes to secure to axial position of the inner and outer pipes.

1. A pipe-in-pipe assembly comprising an inner pipe unit fixedly mounted within an outer pipe unit each end of the inner pipe unit having a coupling means for engagement with a complementary coupling means on an adjacent pipe-in-pipe assembly and arranged such that abutment of an end of the outer pipe unit with an end of the outer pipe unit of said adjacent pipe-in-pipe assembly brings the inner pipe coupling means of the adjacent assemblies into sealed engagement.

2. A pipe-in-pipe assembly according to claim 1, wherein each inner coupling means comprises a tubular member having a generally frusto-conical peripheral surface for engagement with a complementary surface of said inner coupling means of the adjacent pipe assembly.

3. A pipe-in-pipe assembly according to claim 2, wherein the frusto-conical surface has a plurality of circumferentially extending teeth for inter-engagement with teeth on said inner coupling member of the adjacent pipe assembly.

4. A pipe-in-pipe assembly according to any one of the claims 1 to 3, wherein the inner coupling means is formed integrally with the inner pipe.

5. A pipe-in-pipe assembly according to any one of the preceding claims, wherein the inner and outer pipe units have opposed pairs of confronting annular projections for fixedly mounting the inner pipe unit within the outer pipe unit.

6. A pipe-in-pipe assembly according to claim 5. wherein a spacing ring is positioned between each pair of confronting projections.

7. A pipe-in-pipe assembly according to claim 6, wherein the spacing ring has low thermal and electrical conductivity.

8. A pipe-in-pipe assembly according to any one of the preceding claims, wherein sealing means are provided adjacent the free ends of the coupling means

9. A pipe-in-pipe assembly according to any one of the preceding claims, wherein the outer pipe unit has connecting members fixed at '˜ach end.

10. A pipe-in-pipe assembly substantially as herein described with reference to the accompanying drawings.

11. A string of connected pipe-in-pipe assemblies, each assembly being as claimed in any one of claims 1 to 10.
